(19) United States
(12) Patent Application Publication
(10) Pub. No.: US 2015/0006297 A1
(43) Pub. Date: Jan. 1, 2015

(54) GENERATING COMMUNICATIONS INCLUDING CONTENT BASED ON DERIVED ATTRIBUTES

(71) Applicant: ExactTarget, Inc., Indianapolis, IN (US)

(72) Inventor: Kevin Stark, Indianapolis, IN (US)

(21) Appl. No.: 14/317,487

(22) Filed: Jun. 27, 2014

Related U.S. Application Data
(60) Provisional application No. 61/840,198, filed on Jun. 27, 2013.

(51) Int. Cl. G06Q 30/02

(52) U.S. Cl. CPC G06Q 30/0269
USPC 705/14.66

(57) ABSTRACT

Systems, device and techniques are disclosed for creating consumer communications to be provided to a consumer via a channel such as an email, SMS, MMS, personal or private social media message, in-application communication, or the like. A consumer communication template including placeholders for content may be created and an audience may be identified based on derived attributes. A consumer communication may be built based on the communication template for the identified audience. The consumer communication may then be sent to the identified audience based via a respective channel.

### PRIORITY

This application claims the benefit of U.S. Provisional Application No. 61/840,198, filed Jun. 27, 2013, the disclosure of which is incorporated by reference in its entirety.

### BACKGROUND

Traditionally, electronic communication is used to provide consumers with content such as advertisements. Consumers may be provided content that is randomly selected or is selected for the consumer based on one or more collected attributes. As an example, a user A may be located in the United States. The content providing service may receive the user's IP address and determine that the user A is located in the United States. Based on this determination, the user A may be provided with a coupon that is only applicable for stores in the United States. As disclosed herein, content may be provide via any applicable means such as electronic mails, SMS, social-media postings, webpage, application, or the like.

The systems, methods and/or graphical user interfaces disclosed in Dynamic Content Electronic Mail Marketing System and Method, disclosed in pending U.S. application Ser. No. 10/769,095 (published as U.S. Pub. No. 2004/0215479 A1), Email Containing Live Content, disclosed in pending U.S. applications Ser. No. 12/919,982 (published as U.S. Pub. No. 2011/0066692 A1), and System and Method for Providing Real Time Response to Customer Activity, disclosed in pending U.S. Provisional Application Ser. No. 61/768,174 are incorporated herein by reference in their entirety. Additionally, the disclosed systems and methods may be implemented in other systems and methods of providing dynamic content communications with live content.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1A shows an example process for sending consumer communications, according to an implementation of the disclosed subject matter.

FIG. 1B shows another example process for sending consumer communications, according to an implementation of the disclosed subject matter.

FIG. 2A shows an example data model, according to an implementation of the disclosed subject matter.

FIG. 2B shows a contact record, according to an implementation of the disclosed subject matter.

FIG. 3 shows communication schedule, according to an implementation of the disclosed subject matter.

FIG. 4 shows an example contact list, according to an implementation of the disclosed subject matter.

FIG. 5A shows an example filtered list, according to an implementation of the disclosed subject matter.

FIG. 5B shows another example filtered list, according to an implementation of the disclosed subject matter.

FIG. 6 shows an example contact record, according to an implementation of the disclosed subject matter.

FIG. 7 shows an example contact opt-in record, according to an implementation of the disclosed subject matter.

FIG. 8 shows a computer according to an implementation of the disclosed subject matter.

FIG. 9 shows a network configuration according to an implementation of the disclosed subject matter.

### DETAILED DESCRIPTION

In traditional electronic marketing, a consumer may be identified by an email address, SMS number, or other address. Techniques disclosed herein enable content providers such as marketers to build communication lists and content based on derived attributes of recipients in order to increase the likelihood that consumers review such communications. As used herein, a derived attribute refers generally to an attribute that is derived from multiple consumer actions. Each of such actions may indicate an explicit interest of the consumer. The derived attribute may indicate an inferred interest of the consumer that is not an explicit interest indicated by any of the actions taken by the consumer. In some cases, derived attributes may provide more specific or tailored information about a consumer's interests than would otherwise be available based only on the explicit interests and actions themselves. The techniques include a data organization system that seeks to identify consumers and associate all consumer actions from a specific consumer with that consumer. The techniques disclosed herein enhance the traditional model by associating multiple components of known activity and contact information about a consumer into one data model that identifies the consumer directly. This enhancement enables an enterprise to provide relevant communications to consumers through multiple marketing channels based on deriving attributes about each consumer from information known about the consumer.

The techniques disclosed herein enable identifying a more accurate set of consumers to provide consumer communications than traditional techniques. Identifying a more accurate set of consumers (e.g., based on their derived attributes) may enable faster processing and quicker response times by communication centers as well as requiring a reduced cache or memory. As a specific example, an initial list of consumers may contain 1 million entries. Using the techniques disclosed herein, the list of 1 million consumers may be reduced to 80,000 consumers for a given communication based on identified derived attributes related to the consumer that are applicable for the given communication. As a further example, an enterprise may partner with ten companies to send communications (e.g., emails) on their behalf. Using traditional techniques, a communication from each one of the ten companies may be sent to 1 million customers (e.g., 10 million emails), via the enterprise. Using the techniques disclosed herein, the list of 1 million customers may be reduced to between 80,000-100,000 customers for each communication (i.e., between 800,000-1 million communications instead of 10 million communications). Notably, the number of communications may be reduced by 90% and the communications provided by the enterprise may be more targeted compared to those sent via the traditional techniques. The 90% reduction may result in a significant processing and caching saving. The reduction in number of consumers may allow faster processing times, faster communication distribution, reduction in memory and/or cache, or the like.

According to an implementation of the disclosed subject matter, a derived attribute may be based on explicit consumer action(s). Here, an explicit consumer action may result in determining and/or applying a derived attribute instead of or in addition to the inferred technique described herein.

The techniques described herein enable the configuration of certain consumer communications (e.g., via email, SMS, etc.) by an enterprise and of content within such consumer communications. The techniques disclosed herein may produce one or more consumer communications sent to a recipient, such as, via electronic mail, SMS, MMS, social media private or public message, an in-app message, or the like. A private social media message may be one that is provided to a user of a social media platform in a manner that it is only available to the user or is available only to the user and the sender. Essentially, the general public and/or other users connected to the user may not be able to view the message. A public social media message may be one that is visible to multiple users of a social media platform. The message may be associated with a given user (e.g., with a user's personal page) and may be visible to the general public and/or other users connected to the user. As an example, a message may be posted on a User A's personal page such that Users B and C who are friends with User A may also be able to view the message via User A's personal page. An in-app message may be a message provided within an application. An example of an in-app message may be a message provided to a user via a cross-platform instant messaging subscription application.

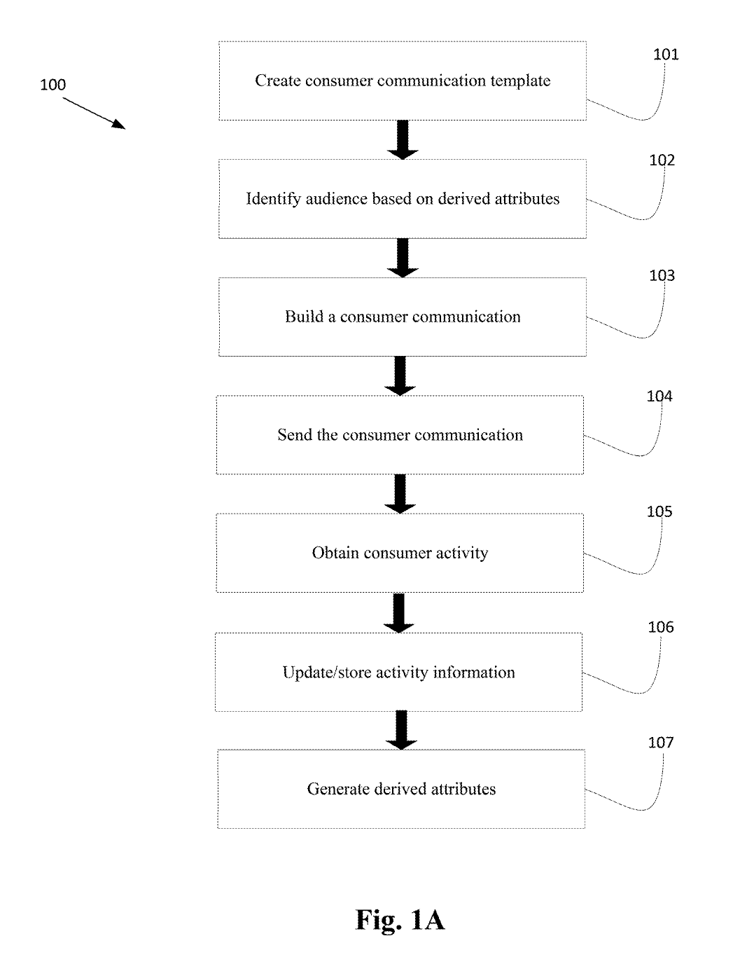

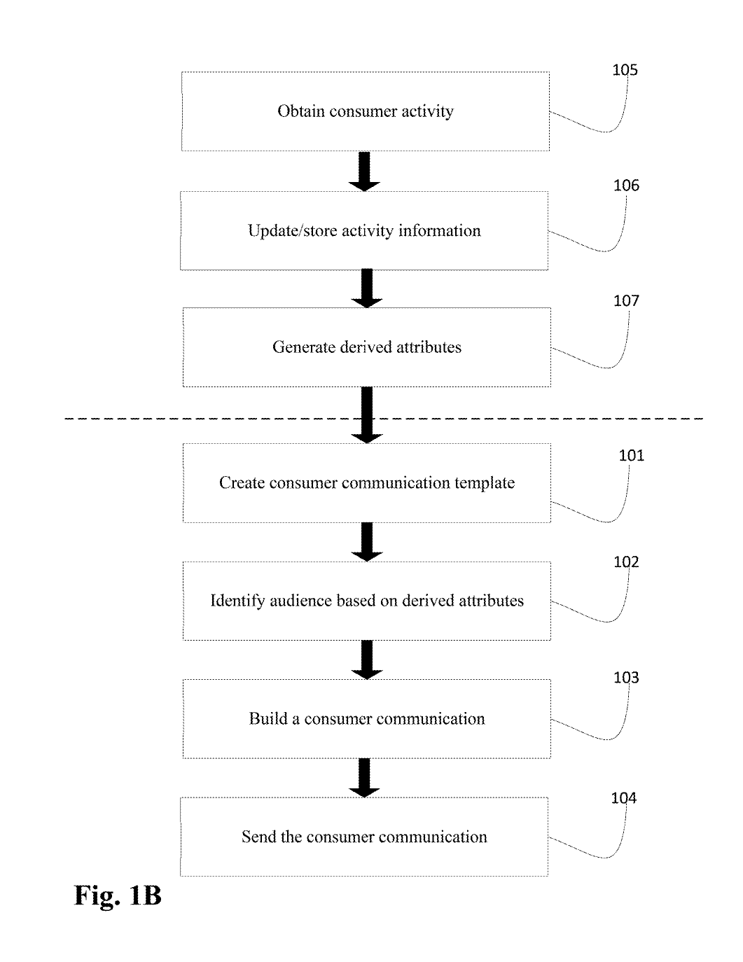

According to implementations of the disclosed subject matter, as shown in FIGS. 1A and 1B, consumer communication may be created and distributed based on derived attributes, as shown by the flowchart 100. As shown at step 101, a consumer communication template may be created. At step 102, an audience may be identified based on derived attributes. As disclosed herein, a derived attribute may be an attribute that is derived as a result of analysis or user action. A derived attribute is not simply a characteristic associated with a user such as a user's email address, IP number, or the like. Derived attributes may be determined based on data received from multiple data sources. The multiple data sources may be datacenters, databases, storage components, or the like. Two different data sources may provide different information. As an example, a first data source may store user purchase history based on credit card transaction history. A second data source may store social media preference information based on user comments. Data from both the first and the second data sources may be provided to an enterprise configured to send consumer communications. An enterprise processor may synthesize the data from the first and second source to generate a derived attribute. At step 103, a consumer communication may be built and may be based on the consumer communication template of step 101. At step 104, the built consumer communication may be sent to the one or more consumers for which the consumer communication was built.

According to implementations of the disclosed subject matter, at step 101 in FIGS. 1A and 1B, a consumer communication template may be created. An entity that intends to distribute consumer communications to its customers or potential customers may have content that includes one or more advertisements or other information that they wish to include in such communications. In addition, such content may include a variety of types, exist in a variety of forms, have certain metrics associated with the content, or the like. As used in the present disclosure, content may include, but is not limited to static content, such as, for example, an image, text block, video, or combination thereof, dynamic content, such as, for example, content that is based on certain demographics of the recipients, such as is disclosed in U.S. patent application Ser. No. 10/769,095, or AMPScript calls, and live content, such as, for example, content that is directed to generate time-specific materials on the opening of a communication, such as is disclosed in U.S. patent application Ser. No. 12/919,982. It will be understood that the content for a consumer communication can include any type of content that may be included within a communication to a recipient.

A communication template may conform to the parameters of the channel for which the consumer communication is to be created. As an example, if the consumer communication to be sent to a consumer is an email, then the communication template may conform to the email process standardized in RFC (Request for Comments publication) 2045 through 2049. As another example, if a consumer communication is an SMS, then the communication template may conform to wireless network standards (e.g., character limits, size limitations, etc.).

A communication template may include designated content areas for various types of content. For example, a communication template may include a live content area, a dynamic content area, static content, or the like. As an example, a communication template may include a live content area. The live content area may include a time-sensitive advertisement that will be generated upon a recipient opening a communication built from the communication template. In this example, the dynamic content area may indicate that, during the build process of the communication, different content will be generated in the dynamic content area based on consumer demographic information. As a more specific example, a determination of the consumer's location may be made when the consumer opens the communication. If the consumer is located in the United States, for example, she may be provided with the advertisement in English whereas if she is located in France, then a French version of the advertisement may be presented. A communication template may include one or more content placeholder variables. A content place holder variable may be a variable (e.g., a hash value) such that when a communication is generated based on the communication template, the content placeholder variable is replaced with content. As an example, a communication template may contain a content placeholder variable of <#42dd83>. A communication based on the communication template may be generated and may replace the content placeholder variable with text corresponding to an intended user's name (e.g., John).

According to implementations of the disclosed subject matter, the communication template created at step 101 may also include content based on derived attributes. As disclosed herein, derived attributes include, but are not limited to, characteristics of a consumer based on consumer actions. Consumer actions may include explicit actions such as, purchasing items or services, contact information, opt-in mailing lists, website activity, email open rates, email click rates, and other types of metrics about a consumer. Derived attributes may indicate an inferred interest of the consumer that is not an explicit interest indicated by any of the actions taken by the consumer. For example, an enterprise intending to create a communication template at step 101 may desire to include a special discount opportunity to highly engaged customers. In this example, the enterprise may set forth a rule set that provides the discount to consumers that open emails from the enterprise at least 25% of the time and not include the discount to consumers that do not meet that criteria. In this example, the enterprise could include this content based on identifying the derived attribute of click rate for its consumers. Here, the individual opening of emails may correspond to customer actions and deriving a likelihood of future success based on the click rate may be the inferred derived attribute. More specifically, the derived attribute may either be the percentage of past email openings or may be the likelihood of successful future openings based on the user's history.

As another example of an inferred derived attribute, a consumer lifetime figure may be calculated based on all of the customer's orders, returns, payments, credits, and the like. The consumer lifetime figure may be the sum of the total order amount less the sum of the total return amount plus any credits. Another example of inferred derived attributes may be a customer's travel history including travel tickets, hotel bookings, rental cars and the like. A derived attribute may be inferred using a machine learning algorithm configured to compute whether a given customer is predisposed to purchase additional items in additional destinations through correlating travel history with similar characteristics in other people. The computation of whether a given customer is predisposed to purchase additional items may be based on comparing the customer's travel history to travel history of other customers. One or more best fit trends may be identified which match the current customer's travel history with those of one or more other customers. Based on the trend and the purchasing habits of the matched one or more other customers, a determination of how likely the current customer is to make a purchase may be made.

According to implementations of the disclosed subject matter, an audience, including one or more consumers, may be identified based on derived attributes at step 102. The derived attribute(s) used to identify one or more consumers at step 102 may be the same as or different from the derived attribute(s) used to identify content at step 101. An entity may identify an audience for receipt of a consumer communication based on information about consumers derived from consumer actions. An audience may include contact information about one or more consumers in one or more communication channels. Contact information may include an identifying address of a consumer for receipt of a communication, such as, for example, a mobile phone number, a social media handle, a social media profile, an application handle, an email address or the like. It will be understood that an audience may include multiple addresses for a single consumer with communications directed to the same consumer over multiple communication channels.

An entity identifying an audience at step 102 may filter contact information from a master list of known consumers based on derived attributes about known consumers. For example, a communication template including information and purchase links to a newly released video game may be generated. Additionally, a User A's purchase history may indicate that User A purchases a video game at the beginning of every quarter of the year (e.g., at the beginning of July—the third quarter of the year). Accordingly, a derived attribute of purchasing a video game per quarter of the year may be generated. Based on the content of the communication template and the derived attribute of the quarterly purchase, User A may be identified as a candidate for a communication if a current time is within two weeks of a new quarter. As a specific example, if a current date is May 25^{th} (i.e 6 days prior to the 3^{rd} quarter of the year beginning on July 1), then the User A may be identified as a candidate for the communication. Alternatively, User A may be excluded from being a candidate for the communication if the current time is outside the two week period as it may be less likely that receiving the video game and purchase information will be useful for the user during that time.

In another example, an enterprise may create a communication template at step 101 which includes content associated with items selected for purchase on a website that were not successfully purchased (i.e. an abandoned shopping cart). The communication template need not actually contain specific items in the communication template. Rather, a communication template may include placeholders or variables that correspond to abandoned shopping cart items such that, for example, an individual user's abandoned shopping cart items replace the variables at a time of building a communication. In this example, the enterprise may select an audience at step 102 based on the derived attributes of consumers with open shopping carts that include at least one item but have not purchased all of the items in the shopping cart. Information associated with a customer's purchase history is stored and can be associated with information associated with a customer's shopping cart in an enterprise's e-commerce website. By combining the information associated with both the open shopping cart and the consumer's purchase history, the enterprise is able to determine whether the consumer has selected items for purchase through the ecommerce website but failed to actually make such purchase. The enterprise may select this derived attribute about consumers to include in an audience for communications at step 102.

In another example, an enterprise may create a communication template at step 101 that includes live content associated with a Black Friday advertisement that is only active for one day. The enterprise may wish to send this communication only to consumers that purchased a product on Black Friday, the previous year. During the audience identification process at step 102, the enterprise may filter its master list of contacts to only include those consumers who purchased at least one product on Black Friday in the previous year.

According to an implementation of the disclosed subject matter, the audience selection process described herein at step 102 may select consumers directly rather than simply selecting a single address (e.g., email, SMS number, in-app handle). By storing and associating consumer actions, contact information, and other attributes about a consumer together, an enterprise is able to identify individual consumers for targeted marketing rather than blast information directed to an individual email address or SMS number. That is, through association contact information, consumer actions, and other information for one consumer, an enterprise may provide targeted communications relevant to that specific consumer through multiple channels.

Selecting a customer (instead of a single address) at step 102 may also enable an enterprise to provide more relevant communications to a consumer at relevant times based on, for example, historical consumer use of channels, customer channel preference determination, customer channel information availability, or the like. For example, if the enterprise knows that a consumer is more likely to open SMS messages between the hours of 6 PM and 7 PM but will otherwise open emails throughout the normal business day, the channel appropriate to communicate with that user varies depending on the time the communication is sent. In this example, the enterprise may obtain derived attributes about the consumer's open rate and most likely channel to open a communication at a given time based on previously obtained consumer actions associated with opening communications.

According to an implementation of the disclosed subject matter, at step 103, a consumer communication may be built. The consumer communication may be built at step 103 by utilizing a communication template created at step 101 and in view of the audience identified at step 102. The communication template may contain all or some of the content for the consumer communication. Alternatively, content may be built into the consumer communication based on information included in the communication template (e.g., one or more content placeholder variables). Alternatively or in addition, content may be selected based on one or more derived attributes associated with a consumer for whom the consumer communication is built.

According to an implementation of the disclosed subject matter, a customer may be communicated with via multiple channels (e.g. via one or more of an email, an SMS, an MMS, a social media public message, a social media private message, an in-application message, etc.). Accordingly, building consumer communications 103 may include creating consumer communications in multiple marketing channels. As an example, an enterprise may build communications for an email channel, SMS, and a social media platform direct message as a result of evaluating derived attributes of consumers selected in the identifying recipients at step 102.

According to implementations of the disclosed subject matter, at step 105 in FIGS. 1A and 1B, consumer actions may be obtained. One or more consumers may interact with a consumer communication sent to the consumer at step 104. An activity may include a consumer opening a communication, click a link within a communication, replying to a communication, and/or otherwise interacting with a communication. Consumer actions by be obtained via included tracing objects within a communication, such as, for example, read receipts within an email, cookies, web beacons, individualized links within a communication imply that a user visited a link, or any other applicable tracing techniques. It will be understood that consumer actions may be generated through any interaction by the consumer with the communication. Further, consumer actions may be obtained and stored by an entity in a local or remote database, server, cloud platform, or the like.

As an example of obtaining consumer actions, a consumer may be sent an email (step 104), and may open the email. Upon opening the email, a web beacon may be loaded within the consumer's email client which notifies an enterprise, associated with sending the email, that the consumer opened the email (step 105). As another example, if the consumer clicks one of the individualized links within the email, the enterprise may also be notified that the consumer clicked the link. As another example, if the consumer replies to the email with the word “UNSUBSCRIBE” in the subject line indicating that the consumer no longer wishes to receive such communications from the enterprise, the enterprise may be notified of the consumer actions associated with the unsubscribe attempt and may stores it in a database where the consumer actions is associated with the consumer.

As another example, a communication sent to a consumer as an SMS message may request that the consumer reply to the SMS message with a certain keyword in order to obtain more information about an enterprise's product. In the event that the consumer replies to the SMS message with the keyword, an enterprise associated with sending the SMS message may obtain the consumer actions (step 105) that the consumer opted in to receiving further communications from the enterprise about the enterprise's product. For example, an enterprise may send an SMS message to a consumer with a picture of a vacuum and the following note: “Text ‘vacuum’ to 555-555-5555 for a special 10% discount coupon on this vacuum!” In the event that the consumer responds to the text message with the keyword vacuum, the enterprise obtains these consumer actions and stores them in a database where it is associated with the consumer.

According to an implementation of the disclosed subject matter, consumer actions obtained at step 105 may include information provided by third party sources. A third party source that provides consumer actions may include a different company than the company sending a consumer communication or providing content for the communication. A third party source may be configured to obtain the consumer actions information such that, for example, a consumer may have authorized the third party source to collect and/or provide the consumer action information. Notably, an enterprise that is associated with sending one or more consumer communications to a user may federate its database of consumer information with a third party's database in order to seamlessly integrate incoming consumer actions into the enterprise's data model associated with the consumer.

According to an implementation of the disclosed subject matter, obtaining consumer actions, at step 105, may include obtaining consumer actions through interaction with one or more web properties. A web property may be any property configured to receive or transmit information via a computer or network. Examples of web properties may include websites/webpages, mobile applications, computer software, or the like. A consumer interacting with one or more web properties may visit links within the web property, read reviews associated with products on the web property, browse various products on the web property, purchase products on the web property, input contact information or other content to the web property and otherwise generally interact with the web property. Through the use of cookies, parameterized URLs, and/or other tracing techniques, an entity may associate such consumer actions directly with a consumer and store such consumer actions in a database at step 105.

As an example, consumer actions obtained through a consumer's interaction with a web property may be associated with the consumer by the consumer clicking an individualized link within a communication which directs to the consumer to the web property. In this example, a communication may include a link with an identifying parameter for the consumer such that when the link is visited, an enterprise may be able to assume with a high level of confidence that it is the consumer visiting the link. Upon visiting the web property through visiting the link, the web property may establish a cookie for the consumer that further associates all web activity associated with the consumer's visit to the web property with the consumer's identity established through the visit of the individualized link from the communication.

According to an implementation of the disclosed subject matter, obtaining consumer actions at step 105 may include obtaining consumer actions generated through a consumer's interaction with communications sent by the enterprise other than the consumer communications described herein (steps 101-107). It should be understood that the techniques disclosed herein are not limited to obtaining consumer actions through a communication sent in the method 100. Accordingly, an enterprise may obtain consumer actions from other communication methods such as previously sent communications to a consumer. As an example, as shown in FIG. 1b, the creation of a communication template at step 101 may occur based on generated derived attribute(s) at step 107 that are based on consumer actions.

According to an implementation of the disclosed subject matter, obtaining consumer actions at step 105 may include receiving and/or analyzing information about a consumer through the consumer's interaction with publicly available resources. Publicly available resources may include any content or information that is available to the public, for no cost or compensation, without consideration, for minimal information in return, or the like. As an example, a user's social media profile may be publically available information. An enterprise may interact with the user's social media profile to learn information about a consumer and/or to store the information as a consumer action at step 105. As a more specific example, a user may provide positive support (e.g., a like, a share, a comment on, a mention, a thumbs up, etc.) for an enterprise's social media page. As a result, the enterprise may store this information as consumer actions at step 105 and associate the activity (i.e., the positive support) with a consumer. It will be understood, however, that the enterprise may obtain information about the consumer through publicly available social media properties when the consumer has not directly engaged the enterprise through that social media property. For example, a consumer actions corresponding to a user mentioning the word “vacuum” in a publicly available social media platform post may be obtained by the enterprise as consumer actions in step 105. Notably, a user need not interact with an enterprise communication, page, profile, or the like for the enterprise to receive and/or analyze information about a consumer through the consumer's interaction with publicly available resources.

According to implementations of the disclosed subject matter, at step 106, activity information may be stored and/or updated. The activity information may be stored locally, remotely, at a database, server, cloud platform, or the like. Further, attributes may be derived about a consumer at step 107, based on activity information stored at step 106. Activity information may be stored consumer actions or activities extracted from consumer actions. Activity information may include, for example, purchase actions, user selections, user search, or the like.

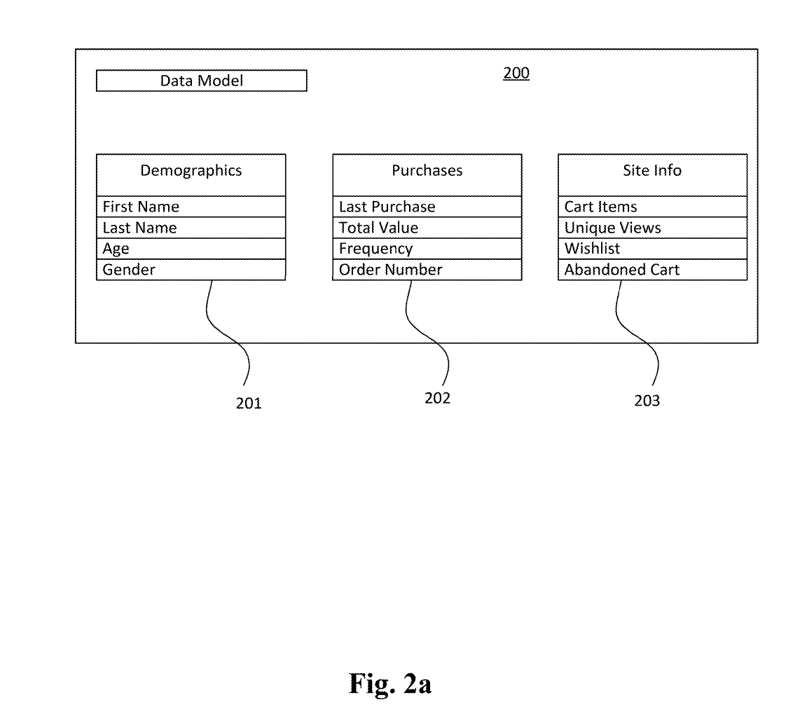

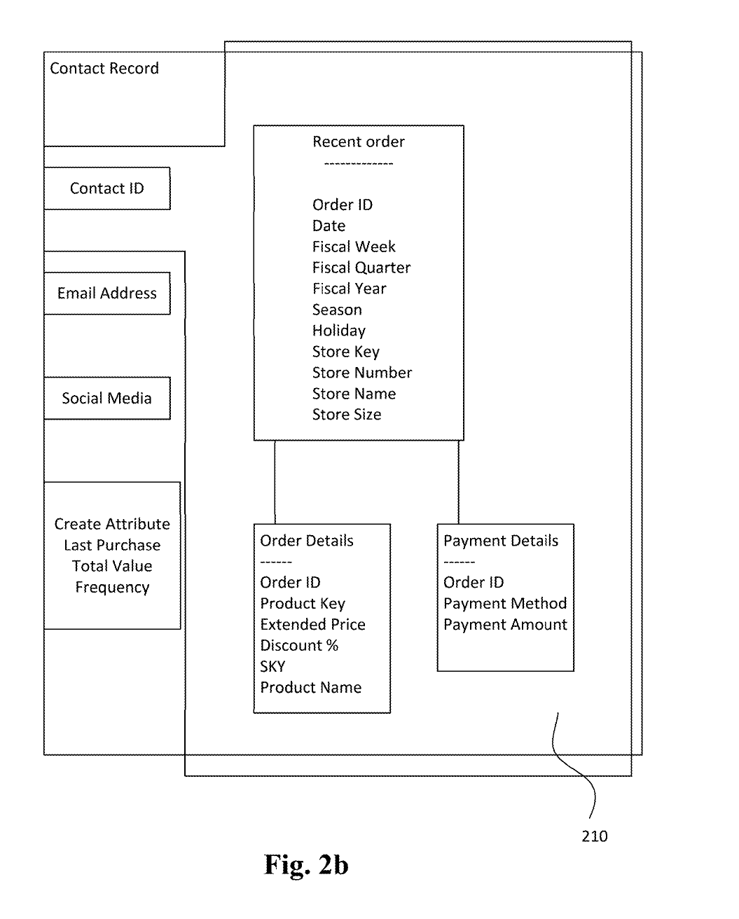

According to implementations of the disclosed subject matter, activity information about a consumer stored at step 106 may be stored in a data model. The data model may include information known about a consumer from various sources in an easily retrievable configuration thereby enabling an enterprise to derive attributes about a consumer from information stored in the data model. For example, information stored in the data model may include consumer actions from an analytics platform, purchase history from a web property, information from a third party, or the like. In at least one implementation of the disclosed subject matter, an enterprise may derive attributes based on information stored in the data model. FIGS. 2A and 2B depict examples of data models containing information that may be derived attributes or may be used to derive attributes. FIG. 2A depicts a data model 200 that includes demographic information 201, purchase information 202 and site information 203 associated with a user and/or a purchases made by a user. Similarly, FIG. 2B shows a data model 210 that associates a contact ID with a recent order, including order details and payment details for that recent order.

As shown in FIGS. 1A and 1B, steps 101-104 and steps 105-107 may be cyclical or out of order such that a set or individual steps may occur before the other. At step 105, consumer actions may be obtained and activity information may be updated and/or stored at step 106, based on obtaining the consumer actions. Derived attributes may be generated based on the updated/stored activity information at step 107. For example, an enterprise may create an ecommerce platform that sells products. In this example, the enterprise may place a tracking cookie into any visitor of the ecommerce website in order to track all activity associated with that visitor. Consumers may interact with the ecommerce platform to view products without making any purchases. During the process of the consumer interacting with the ecommerce platform, the ecommerce platform may associate consumer actions with the unique identifier in the cookie. In this example, contact information about the consumer may not be stored at the enterprise. Accordingly, communications may not be provided to the consumer until the consumer provides such information through the ecommerce platform, such as, for example, by purchasing a product or opting in to receiving communications. In this example, an enterprise entity (e.g., as a server, database, etc.) may store consumer actions about the consumer prior to knowing the consumer's identity or any contact information about the consumer.

According to an implementation of the disclosed subject matter, communications may be generated by an enterprise entity based on derived attributes from one or more pre-built templates. For example, an enterprise may have prebuilt templates that enable the enterprise to create lists and communications based on derived attributes from analytics, purchase histories, an abandoned shopping cart, unengaged consumers, or the like.

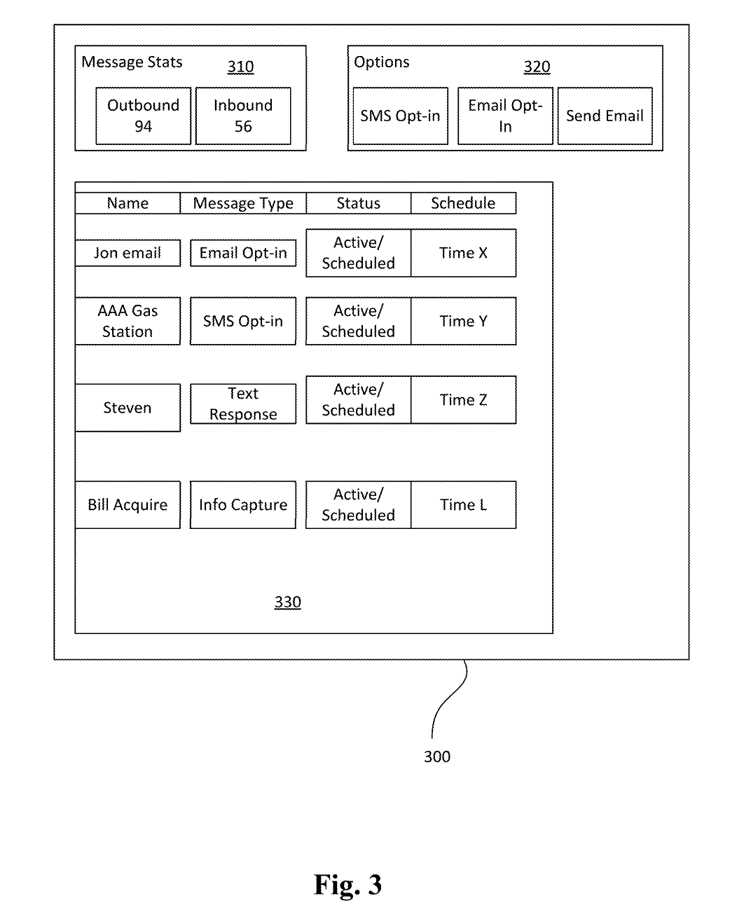

In an illustrative example of an implementation of the disclosed subject matter, FIG. 3 shows a graphical interface for scheduled consumer communications. The consumer communications may be based on derived attributes of the corresponding consumers, as disclosed herein. As shown in FIG. 3, the graphical user interface 300 provides a display of available communications and campaigns for an enterprise to send to an audience in the options box 320. The graphical user interface may also provide statistics about outbound and inbound messages in box 310. In box 330, scheduled consumer communications may be displayed and may include information about the communication such as the name of the communication and/or a consumer, the message type, a status, and/or a schedule. It will be understood that that the graphical user interface 300 may assist the enterprise in performing steps of in FIGS. 1A and 1B, including, for example, steps 101 through 104 in building and sending communications.

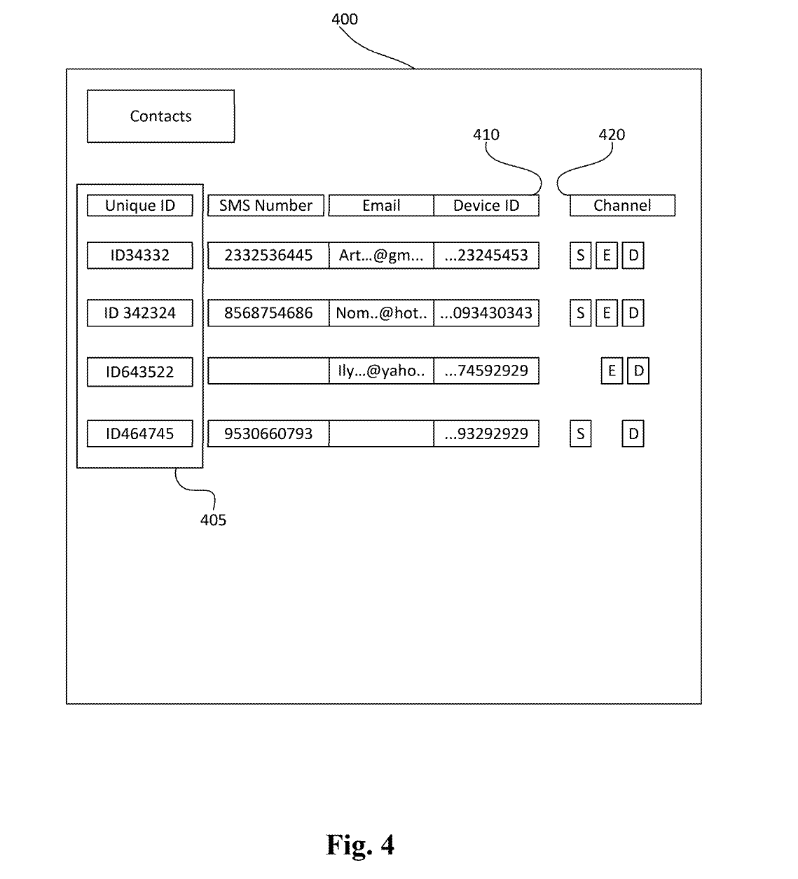

In an illustrative example of an implementation of the disclosed subject matter, FIG. 4 shows a graphical interface of contacts available to an enterprise along with the channel information associated with the contacts. As shown in FIG. 4, the graphical user interface 400 shows a data model of contact information for a consumer that includes a set of known marketing channels in which the consumer may be contacted. For example, the graphical user interface 400 shows a set of marketing channels in which the consumer may be contacted 410 that includes social SMS numbers, emails, and device IDs that are all associated based on a unique identifier 405 for a consumer. Although not shown in FIG. 4, it will be understood that additional channels such as social media, in-app communication, and the like may also be available to an enterprise. As shown in the Channel selection portion 420, an enterprise may select one or more of the available channels for a given contact and create or send a consumer communication via that channel. Here, S corresponds to SMS, E corresponds to email, and D corresponds to device. As shown, only the options, for which there is corresponding channel information, are displayed.

Further, as shown in FIG. 4, the graphical user interface 400 also includes a unique identifier for a consumer 405. This unique identifier 405 enables the enterprise to associate consumer actions with a consumer prior to obtaining any contact information about the consumer. In addition, the unique identifier 405 enables the enterprise to provide a non-changing value for the consumer that is preserved even if the consumer's contact information changes.

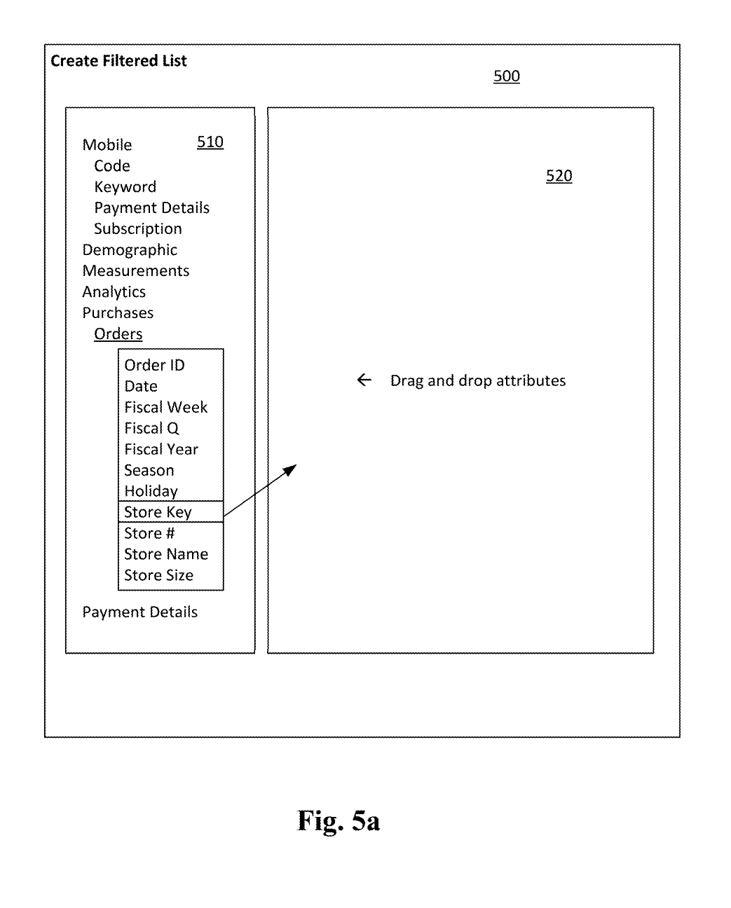

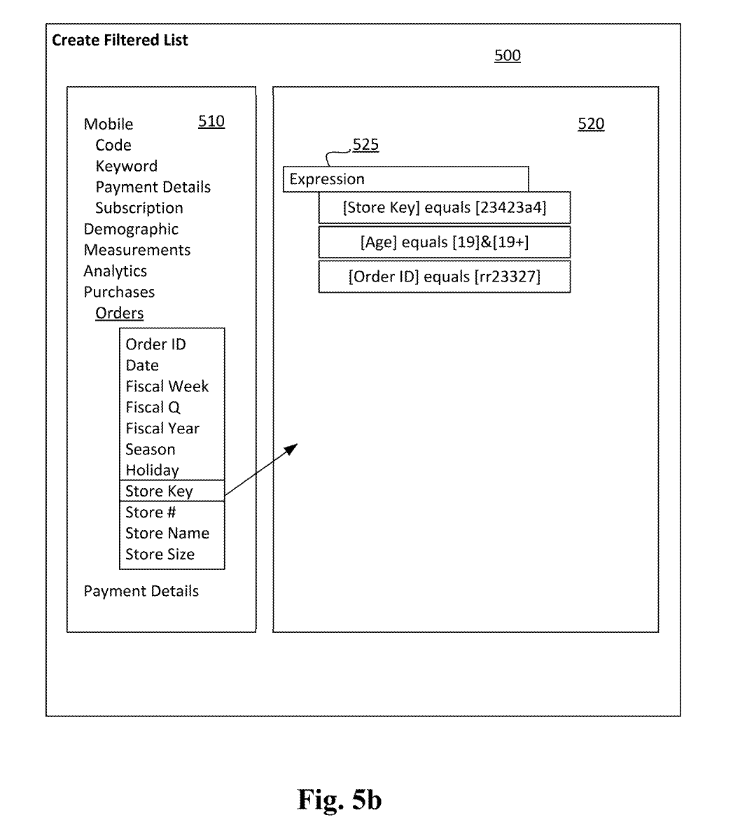

In an illustrative example of the disclosed subject matter, as shown in FIG. 5A, a graphical user interface 500 may be used to provide consumer communications to a consumer based on derived attributes, based on at least one implementation of the disclosure subject matter. The graphical user interface 500 may enable an enterprise to generate a filtered list of consumers based on derived attributes, demographic information, contact information, and other attributes of a consumer such as described in step 102 in FIGS. 1A and 1B. As shown in FIG. 5A, a graphical user interface 500 may include a list 510 which can be used to select or create derived attributes by dragging and dropping one or more attributes from the list 510 to the implementation box 520.

As disclosed herein, an enterprise may build an audience list, from a master audience list, by including a variety of attributes into a filter such that the new audience is a subset of the master audience list. A subset may include, for example, purchase history analytics information, measures, demographics, keywords, payment details (e.g., credit card information, online payment, etc.), and other information. As an illustrative example, as shown in FIG. 5A a filtered list 500 may contain a user interface list 510. An enterprise user may click and drag various attributes from the user interface list 510 into an implementation box 520. An audience may be built based on filtering the master list of audience based on the attributes dragged into implementation box 520.

As shown, for example, in FIG. 5B, an enterprise may drag multiple attributes into the implementation box 520 to build an expression 520 that limits an audience. In this example, the implementation box 520 includes attributes based on a store key from where a purchase is made, the age of a consumer, and an order ID corresponding to a purchase. The implementation box 520 may include any attribute within the data model, including derived attributes, in order to filter a master list of consumers into a smaller subset for the distribution of communications and/or unique identification of content within a communication in one or more content areas.

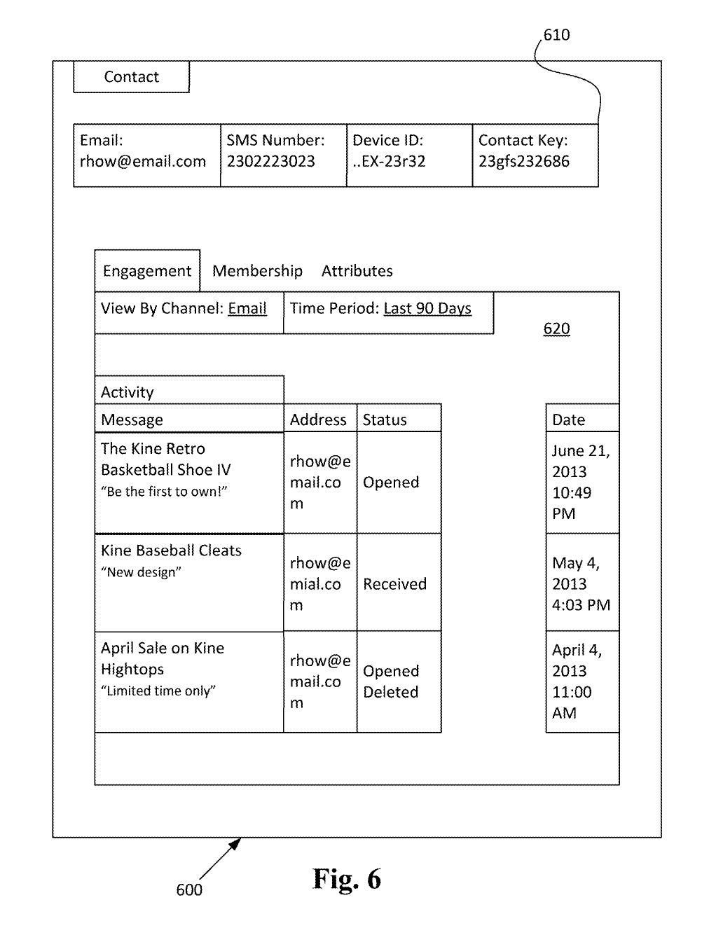

FIG. 6 shows an illustrative example of viewing consumer actions for a specific consumer. As shown FIG. 6, a data model 600 that stores all information known about a consumer's activity with an enterprise provides a single pane view into consumer actions. The data model 600 shows the consumer identification information in plane 610 and consumer communications associated with a channel in plane 620. An enterprise may have access to the address of each communication sent by the enterprise to a consumer and whether the consumer opened the communication and clicked a link within the communication. The enterprise may also view this information by channel and the information may include marketing communications sent by the enterprise and general engagement communications sent by the enterprise. It will be understood that although FIG. 6 shows the selection of email messages within the last 90 days, any other combination of channel and time range may be selected for viewing corresponding consumer communications.

In an implementation of the disclosed subject matter, the consumer actions stored in the data model, such as the one shown in FIG. 6, may be referenced by an enterprise in creating a filtered list of consumers for specific targeted messages based on derived attributes from the consumer actions. For example, FIG. 6 discloses that the user with contact key “23gfs232686” is associated with the email address rhow@email.com, SMS Number “2302223023”, and a fingerprinted device ID. In this example, the enterprise also has obtained consumer actions indicating that the user has opened emails advertising the Kine Retro Basketball Shoe IV and Kine Hightops. Therefore, the enterprise in this example may send follow up communications to consumers that have shown an interest in those shoes. In this example, the enterprise may filter its master list of consumers to only include those consumers that are interested in Kine Retro Basketball Shoe IV and Kine Hightops. To select this specific audience, the enterprise may evaluate consumer actions to identify the derived attribute desired. In this example, the user would be identified within this audience based on the derived attribute that she is interested in Kine Retro Basketball Shoe IV and Kine Hightops, as shown through her consumer actions of opening emails advertising these shoes.

Continuing the example, the enterprise may send SMS messages to the user (i.e., contact key “23gfs232686”) based on derived attributes from email activity because the enterprise has stored the contact information for the user which includes the user's mobile number. Accordingly, as the enterprise may determine that the user is interested in Kine Retro Basketball Shoe IV based on the user's email communication, the enterprise may send a corresponding SMS to the user about purchasing the same shoe. In this example, if the enterprise identifies multiple mobile numbers stored for the same user, then the enterprise may send the SMS for which the user has history of opening SMS messages more so than the other numbers stored for the user.

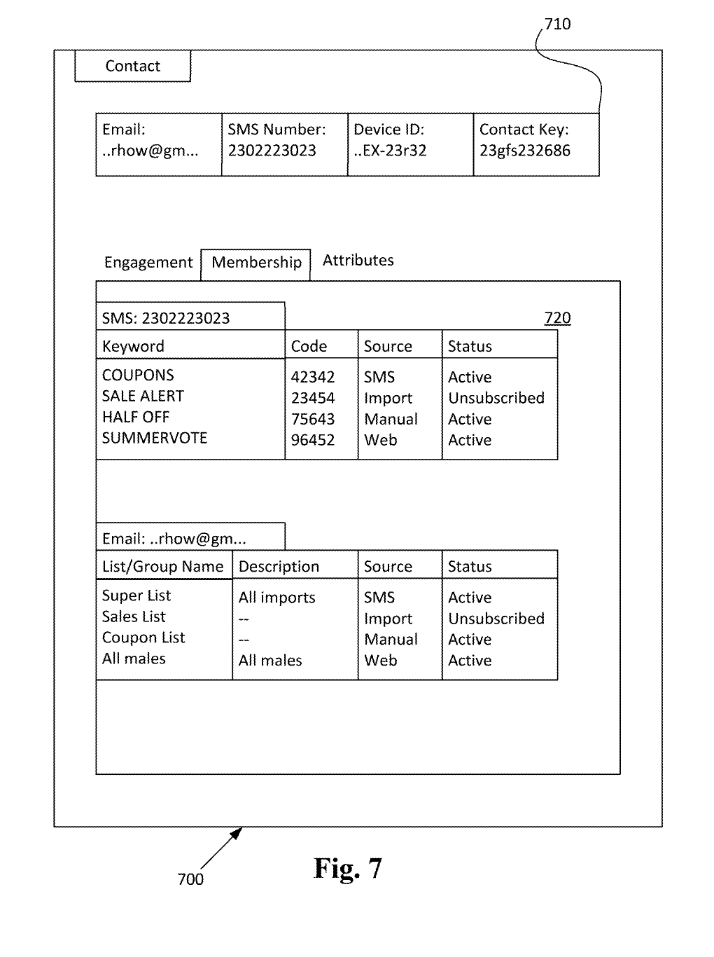

FIG. 7 shows an illustrative example of a graphical user interface of a system for providing communications to consumers based on derived attributes according to at least one implementation of the disclosed subject matter. As shown in FIG. 7, attributes based on consumer actions related to opt-in membership to various enterprise marketing newsletters and previously created audience lists may be derived. In this example, an enterprise may create audience lists and save such lists for subsequent filtering of a master contact list. As shown, the user is associated with the previously created email lists of “All Males”, “Coupon List”, “Super List” and “Sales List”. In this example, the user has unsubscribed to the “Sales List”. In this example, the user has also opted in to various keywords through SMS, including the “COUPONS”, “HALFOFF”, “SUMMERVOTE”, and “SALE ALERT” keywords. In this example, the user has unsubscribed from the “SALE ALERT” keyword.

This consumer actions associated with the user may enable the enterprise to build subsequent filtered lists based on derived attributes generated from the user's involvement with various other marketing campaigns. For example, if the enterprise wanted to send a communication that offered a male audience a discount on shaving cream, the enterprise could create a list of all users that have opted in to the “COUPONS” keyword and “All Males” list. This combination of two lists enables the enterprise to provide a targeted marketing communication to a subset of its users that is more likely to be engaged by recipients because the recipients are part of previously opted-in lists showing interest in this type of communication.

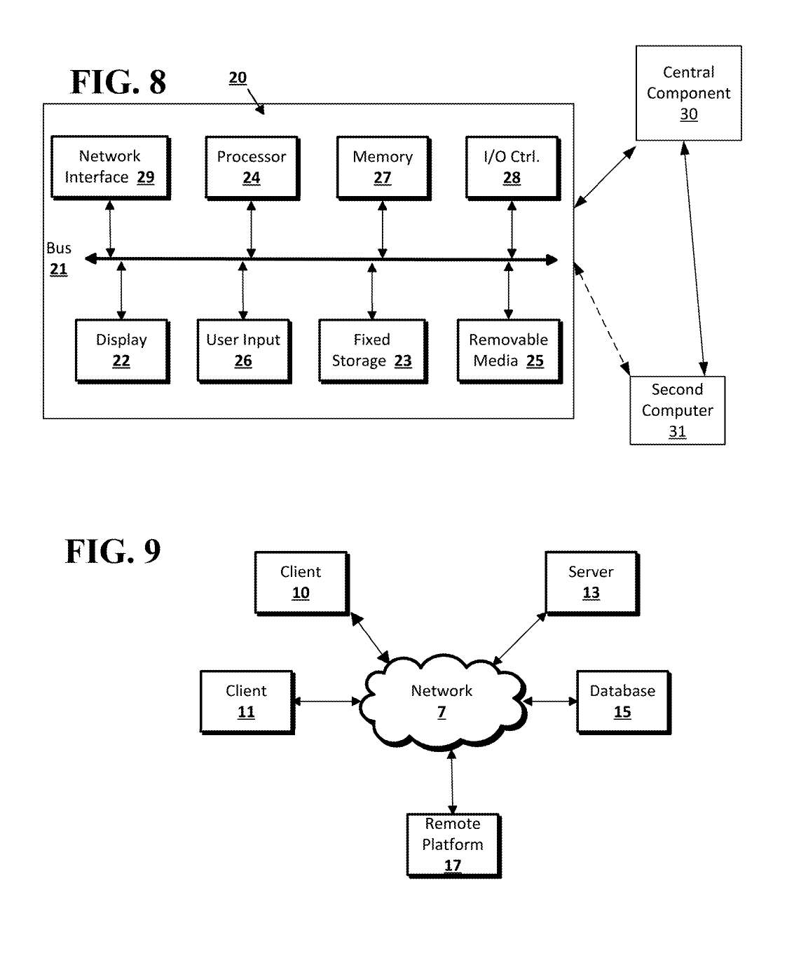

Implementations of the presently disclosed subject matter may be implemented in and used with a variety of component and network architectures. FIG. 8 is an example computer 20 suitable for implementing implementations of the presently disclosed subject matter. As discussed in further detail herein, the computer 20 may be a single computer in a network of multiple computers. As shown in FIG. 8, computer may communicate a central component 30 (e.g., server, cloud server, database, etc.). The central component 30 may communicate with one or more other computers such as the second computer 31. According to this implementation, the information obtained to and/or from a central component 30 may be isolated for each computer such that computer 20 may not share information with computer 31. Alternatively or in addition, computer 20 may communicate directly with the second computer 31.

The computer (e.g., user computer, enterprise computer, etc.) 20 includes a bus 21 which interconnects major components of the computer 20, such as a central processor 24, a memory 27 (typically RAM, but which may also include ROM, flash RAM, or the like), an input/output controller 28, a user display 22, such as a display or touch screen via a display adapter, a user input interface 26, which may include one or more controllers and associated user input or devices such as a keyboard, mouse, WiFi/cellular radios, touchscreen, microphone/speakers and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 enable data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may enable the computer to communicate with other computers via one or more local, wide-area, or other networks, as shown in FIG. 9.

Many other devices or components (not shown) may be connected in a similar manner (e.g., document scanners, digital cameras and so on). Conversely, all of the components shown in FIG. 8 need not be present to practice the present disclosure. The components can be interconnected in different ways from that shown. The operation of a computer such as that shown in FIG. 8 is readily known in the art and is not discussed in detail in this application. Code to implement the present disclosure can be stored in computer-readable storage media such as one or more of the memory 27, fixed storage 23, removable media 25, or on a remote storage location.

FIG. 9 shows an example network arrangement according to an implementation of the disclosed subject matter. One or more clients 10, 11, such as computers, microcomputers, local computers, smart phones, tablet computing devices, enterprise devices, and the like may connect to other devices via one or more networks 7 (e.g., a power distribution network). The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15. Information from or about a first client may be isolated to that client such that, for example, information about client 10 may not be shared with client 11. Alternatively, information from or about a first client may be anonymized prior to being shared with another client. For example, any client identification information about client 10 may be removed from information provided to client 11 that pertains to client 10.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method for comprising:
for each of a plurality of consumers:
obtaining electronic records of a plurality of actions taken by the consumer, each of the plurality of actions indicating an explicit interest of the consumer; and
based upon the plurality of actions, generating a first derived attribute of the consumer, the first derived attribute indicating a presence or absence of an inferred interest of the consumer that is not an explicit interest indicated by any of the plurality of actions taken by the consumer;
selecting, from among the plurality of consumers, those consumers for which the first derived attribute indicates the presence of the inferred interest;
generating a first content based upon the first derived attribute, the first content providing information related to the inferred interest;
generating a first electronic consumer communication including the first content; and
sending the first electronic consumer communication to each selected consumer from among the plurality of consumers.

2. The method of claim 1, wherein the first electronic consumer communication is sent via at least one channel selected from the group consisting of: an email, an SMS, an MMS, a social media public message, a social media private message, and an in-application message.

3. The method of claim 1, wherein sending the first electronic consumer communication further comprises:
identifying each selected consumer from among the plurality of consumers via a unique consumer ID;
determining a channel based on identifying each selected consumer from among the plurality of consumers via the unique customer ID; and
sending the first electronic consumer communication to the consumer via the determined channel.

4. The method of claim 3, wherein determining the channel further comprises selecting a channel based on one selected from the group consisting of: a historical consumer use of channels, a customer channel preference determination, and a customer channel information availability.

5. The method of claim 3, wherein determining the channel further comprises:
identifying a time for the first communication to be sent; and
selecting a channel based on historical consumer use during that time.

6. The method of claim 1, further comprising creating a communication template, wherein the first electronic consumer communication is generated based on the communication template.

7. The method of claim 6, wherein the communication template conforms to the parameters of the channel for the consumer communication.

8. The method of claim 6, wherein the communication template contains at least one content placeholder variable.

9. The method of claim 6, further comprising building the first consumer communication based on the communication template.

10. The method of claim 1, further comprising sending a second electronic consumer communication to the consumer, wherein the second consumer communication is sent via a different channel than the channel for the first consumer communication.

11. The method of claim 1, further comprising:
receiving an interaction, by one or more selected consumer from among the plurality of consumers, with the first electronic consumer communication including the first content; and
storing the interaction as a consumer action.

12. The method of claim 11, wherein the interaction is one from the group consisting of: an opening a communication, a clicking a link within a communication, and a replying to a communication.

13. The method of claim 11, wherein the interaction is received as a result of one selected from the group consisting of: a read receipts within an email, a cookie, a web beacon, a selection of a link within a consumer communication, a publically available resource, and an interaction with a web property.

14. The method of claim 11, wherein the interaction is provided by a third party.

15. The method of claim 1, further comprising:
obtaining at least one of the plurality of actions from a third party;
determining the inferred interest based on obtaining at least one of the plurality of actions from a third party; and
generating the first derived attribute based on the determination.

16. The method of claim 15, wherein the third party is a publically available resource.

17. A system for generating communications containing content based on derived attributes, the system comprising:
a database, the database configured to store a plurality of consumer actions for each of a plurality of customers, each of the plurality of actions indicating an explicit interest of the consumer;
a first server, the first server electronically coupled to the database and configured to:
based upon the plurality of actions, generate a first derived attribute of the consumer, the first derived attribute indicating a presence or absence of an inferred interest of the consumer that is not an explicit interest indicated by any of the plurality of actions taken by the consumer;
select, from among the plurality of consumers, those consumers for which the first derived attribute indicates the presence of the inferred interest;
generate a first content based upon the first derived attribute, the first content providing information related to the inferred interest;
generate a first electronic consumer communication including the first content; and
send the first consumer communication to each selected consumer from among the plurality of consumers.
